(19) United States
(12) Patent Application Publication
(10) Pub. No.: US 2002/0096260 A1
(43) Pub. Date: Jul. 25, 2002

(54) Labeling machine with container spacer device

(76) Inventor: Sheng-Hui Yang, Taichung City (TW)

Correspondence Address: HARNESS, DICKEY & PIERCE, P.L.C., 5445 Corporate Drive, Troy, MI, 48098, US

(21) Appl. No.: 09/768,100

(22) Filed: Jan. 23, 2001

(51) Int. Cl. B32B 31/00

(52) U.S. Cl. 156/351; 156/363; 156/566

(57) ABSTRACT

A labeling machine includes a label applying unit operable so as to attach a label to a first one of a plurality of containers being conveyed by a conveying unit when the first one of the containers is aligned with a label applicator plate. A container spacer device includes a spacer wheel driven rotatably by a spacer motor and adapted to contact one of the containers that is behind the label applicator plate in an advancing direction of the conveying unit such that rotation of the spacer wheel can result in retarding or advancing of the contacted one of the containers on the conveying unit, thereby resulting in a spacing between adjacent ones of the containers. A controller is coupled electrically to the spacer motor, a container sensor and the label applying unit, activates the label applying unit according to a container detect signal generated by the container sensor, and controls the spacer motor to vary rotational speed of the spacer wheel according to length of time between successive ones of the container detect signals from the container sensor so that successive ones of the containers can be appropriately spaced apart prior to reaching the label applicator plate.

### BACKGROUND OF THE INVENTION

1. Field of the Invention

The invention relates to a labeling machine, more particularly to a labeling machine with a container spacer device.

2. Description of the Related Art

Commodities, such as beverage bottles, drug bottles, containers, and packaging boxes, are generally provided with a label to classify products, to indicate usage and other information, to display the trademark or logo of the manufacturer, etc. With the recent advancement in automation, automated attachment of labels to such commodities has taken the place of manual label attachment, and has become quite popular in the industry.

In a conventional label attaching process, a reel of labels is arranged on a reel supporting plate. A leading edge of the reel is drawn via a driving device to a label applicator plate where the labels are applied to containers being advanced by a container conveyer.

Although the conventional labeling machine can perform automatic label attaching, since containers are disposed manually on a container conveying unit thereof, an appropriate spacing between successive ones of the containers sufficient for label attachment cannot be maintained. Particularly, when the spacing between adjacent containers is too short, defective products might arise during the label attaching process, and manual adjustment of the spacing is thus required. When the spacing between adjacent containers is too long, a reduction in the production efficiency is incurred.

### SUMMARY OF THE INVENTION

Therefore, the main object of the present invention is to provide a labeling machine with a container spacer device that can appropriately adjust a spacing between adjacent containers during a label attachment operation.

According to the present invention, a labeling machine includes a container conveying unit, a label applying unit, a container sensor, a container spacer device and a controller.

The container conveying unit has a feed-in end and a take-out end, and is adapted to successively convey a plurality of containers from the feed-in end to the take-out end.

The label applying unit includes a label applicator plate disposed adjacent to the conveying unit between the feed-in and take-out ends. The label applying unit is operable so as to be adapted to attach a label to a first one of the containers that are conveyed by the conveying unit when the first one of the containers is aligned with the label applicator plate.

The container sensor is disposed adjacent to the conveying unit between the feed-in end and the label applicator plate. The container sensor generates a container detect signal when another one of the containers that is behind the first one of the containers in an advancing direction of the conveying unit is registered therewith.

The container spacer device is disposed adjacent to the conveying unit between the feed-in end and the container sensor. The container spacer device includes a spacer motor and a spacer wheel driven rotatably by the spacer motor. The spacer wheel is adapted to contact a further one of the containers that is behind said another one of the containers in the advancing direction of the conveying unit such that rotation of the spacer wheel can result in retarding or advancing of said further one of the containers on the conveying unit, thereby resulting in a spacing between said another and further ones of the containers.

The controller is coupled electrically to the spacer motor, the container sensor and the label applying unit. The controller activates the label applying unit according to the container detect signal from the container sensor, and controls the spacer motor to vary rotational speed of the spacer wheel according to length of time between successive ones of the container detect signals from the container sensor so that successive ones of the containers can be appropriately spaced apart prior to reaching the label applicator plate.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view of the preferred embodiment of a labeling machine according to this invention;

FIG. 2 is a schematic circuit block diagram of the preferred embodiment;

FIG. 3 is a perspective view of a container spacer device of the preferred embodiment;

FIG. 4 is a schematic view illustrating operation of the preferred embodiment; and

FIG. 5 is a flow chart illustrating operation of a controller of the preferred embodiment.

### DETAILED DESCRIPTION OF THE PREFERRED EMBODIMENT

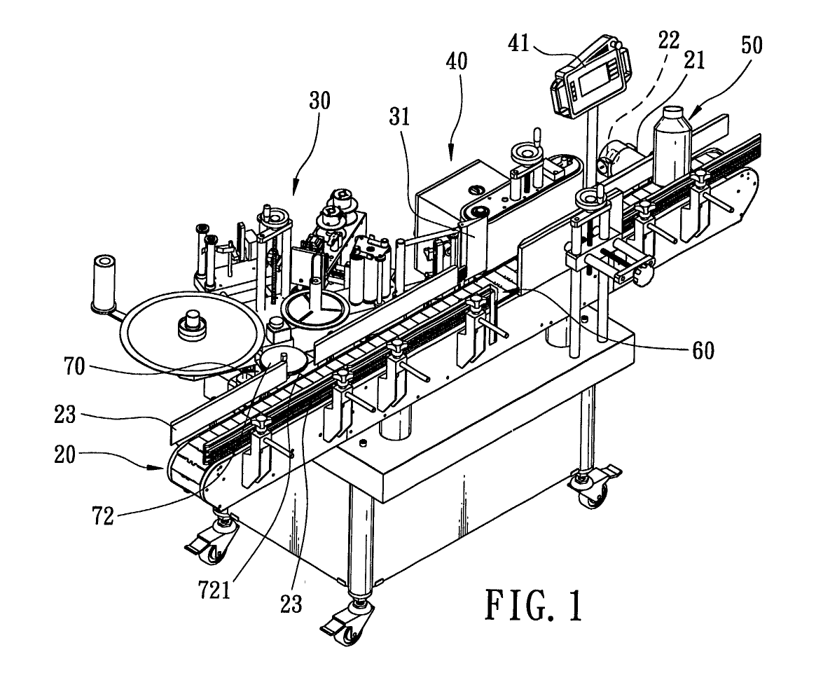

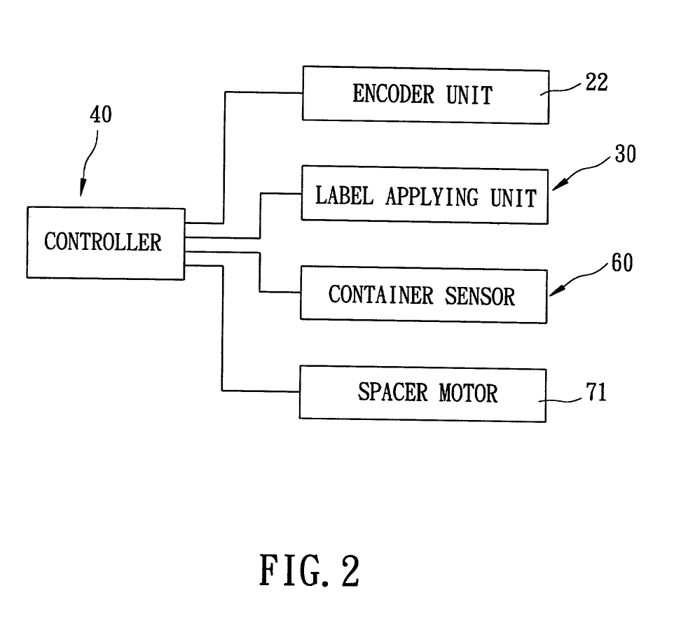

Referring to FIGS. 1 and 2, the preferred embodiment of a labeling machine according to this invention is shown to include a container conveying unit 20, a label applying unit 30, a container sensor 60, a container spacer device 70, a controller 40, and an encoder unit 22.

The conveying unit 20 is of a known type having a feed-in end and a take-out end. The conveying unit 20 is driven by a motor 21, and is adapted to successively convey a plurality of containers 50 from the feed-in end to the take-out end.

The label applying unit 30 includes a label applicator plate 31 disposed adjacent to the conveying unit 20 between the feed-in and take-out ends. The label applying unit 30 is operable so as to be adapted to attach a label to a first one of the containers 50 being conveyed by the conveying unit 20 when the first one of the containers 50 is aligned with the label applicator plate 31. As the label applying unit 30 is known in the art, and since the feature of the invention does not reside in the particular configuration of the same, a detailed description thereof will not be provided herein for the sake of brevity.

The container sensor 60 is disposed adjacent to the conveying unit 20 between the feed-in end and the label applicator plate 31. The container sensor 60 generates a container detect signal whenever one of the containers 50 being conveyed by the conveying unit 20 is registered therewith.

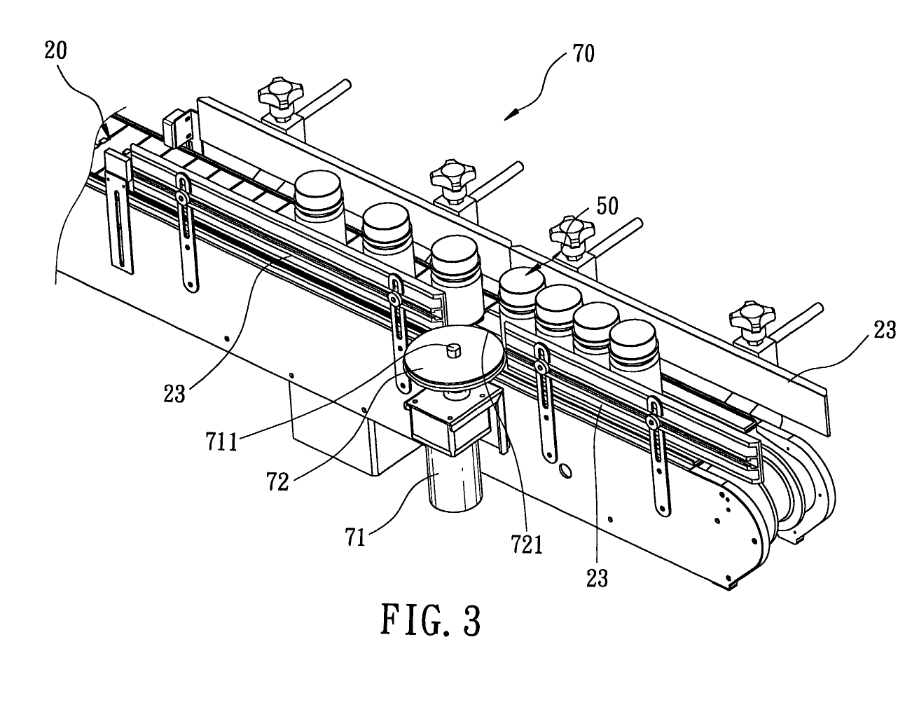

The container spacer device 70 is disposed adjacent to the conveying unit 20 between the feed-in end and the container sensor 60. The container spacer device 70 includes a spacer motor 71, and a spacer wheel 72 coupled to a shaft 711 of the spacer motor 71 and driven rotatably by the spacer motor 71. Referring to FIG. 3, the spacer wheel 72 is made from a resilient rubber material, and has an edge portion 721 that extends above the conveying unit 20 via a gap formed in a fence 23. The edge portion 721 of the spacer wheel 72 is adapted to contact a rear one of the containers 50 that is behind a front one of the containers 50 in the advancing direction of the conveying unit 20 such that rotation of the spacer wheel 72 can result in retarding or advancing of the rear one of the containers 50 on the conveying unit 20, thereby resulting in a spacing between the front and rear ones of the containers 50.

The controller 40 is coupled electrically to the spacer motor 71, the container sensor 60 and the label applying unit 30. The controller 40 activates the label applying unit 30 according to the container detect signal from the container sensor 60, and controls the spacer motor 71 to vary rotational speed of the spacer wheel 72 according to length of time between successive ones of the container detect signals from the container sensor 60 so that successive ones of the containers 50 can be appropriately spaced apart prior to reaching the label applicator plate 31.

The encoder unit 22 is associated with the conveying unit 20, and is coupled electrically to the controller 40. The encoder unit is operable so as to provide distance information to the controller 40 to indicate distance advanced by the first one of the containers 50 during attachment of the label thereon. The controller 40 determines the appropriate spacing between the successive ones of the containers 50 based on the distance information from the encoder unit 22, and controls the spacer motor 71 according to the appropriate spacing determined thereby. In this embodiment, the encoder unit 22 is coupled to a main shaft (not shown) of the motor 21, and generates 1000 signals for each cycle of rotation of the main shaft. In the preferred embodiment, each signal corresponds to a distance of about 0.34 mm advanced by the conveying unit 20.

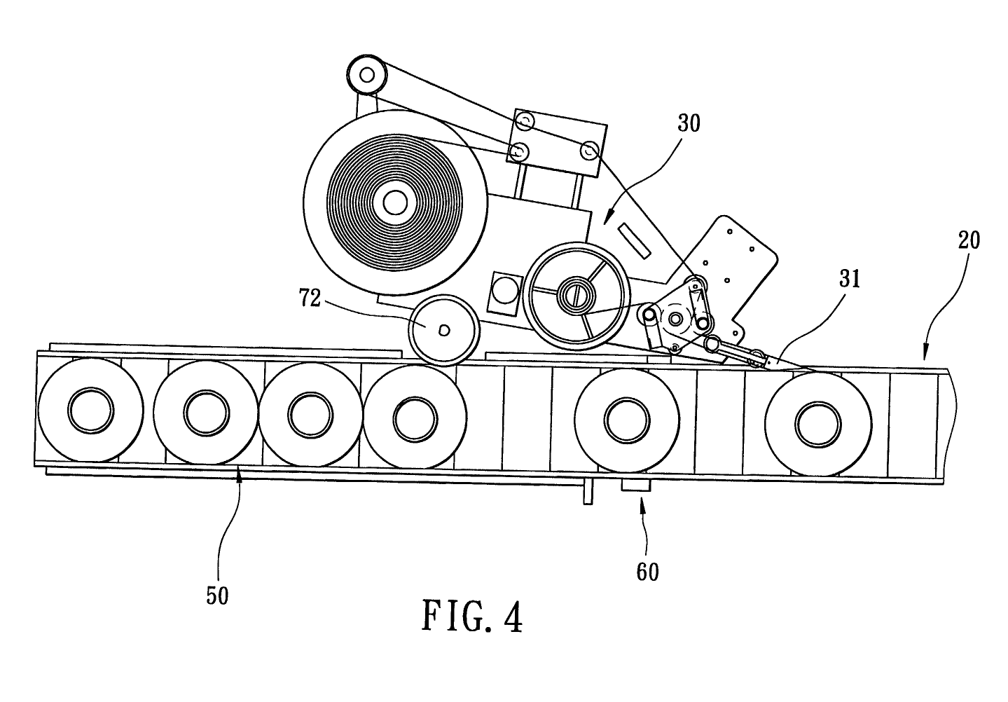

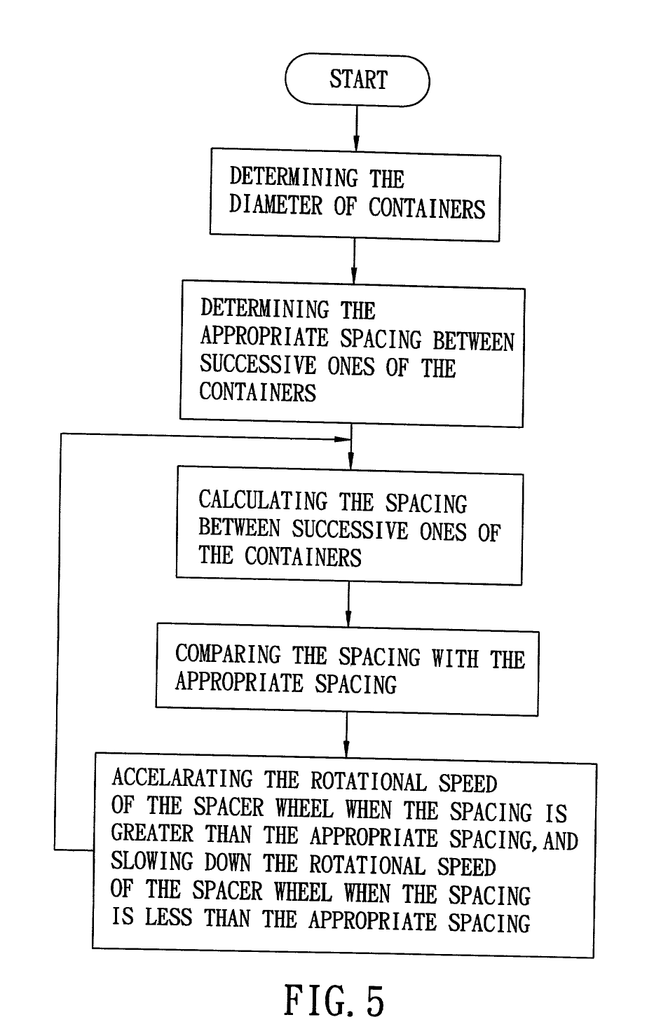

The operation of the labeling machine will now be described with reference to FIGS. 4 and 5. First of all, the diameter of the containers 50 can be determined according to the number of signals generated by the encoder unit 22 when the first one of the containers 50 passes through the container sensor 60. The appropriate spacing between successive ones of the containers 50 can be set to be equal to the radius of the containers 50. For example, the encoder unit 22 generates 100 signals when the first one of the containers 50 passes through the container sensor 60. As such, the diameter of the containers 50 is equal to 34 mm (0.34 mm×100=34 mm), and the appropriate spacing between successive ones of the containers 50 is equal to 17 mm. When the encoder unit 22 generates 150 signals between a trailing edge of the first one of the containers 50 and a leading edge of another one of the containers 50 that is behind the first one of the containers 50 in the advancing direction of the conveying unit 20 and that passes through the container sensor 60, a spacing between the first and said another ones of the containers 50 is found to be equal to 51 mm (0.34 mm×150=51 mm), which is greater than the appropriate spacing. At this time, the controller 40 controls the spacer motor 71 to accelerate the rotational speed of the spacer wheel 72, thereby resulting in advancing of a further one of the containers 50 that is behind said another one of the containers 50 on the conveying unit 20. Accordingly, when the spacing between the first and said another ones of the containers 50 is less than the appropriate spacing, the controller 40 controls the spacer motor 71 to slow down the rotational speed of the spacer wheel 72, thereby resulting in retarding of said further one of the containers 50 on the conveying unit 20 so as to widen the spacing between said another and further ones of the containers 50.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A labeling machine comprising:
a container conveying unit having a feed-in end and a take-out end, said conveying unit being adapted to successively convey a plurality of containers from said feed-in end to said take-out end;
a label applying unit including a label applicator plate disposed adjacent to said conveying unit between said feed-in and take-out ends, said label applying unit being operable so as to be adapted to attach a label to a first one of the containers being conveyed by said conveying unit when the first one of the containers is aligned with said label applicator plate;
a container sensor disposed adjacent to said conveying unit between said feed-in end and said label applicator plate, said container sensor generating a container detect signal when another one of the containers that is behind the first one of the containers in an advancing direction of said conveying unit is registered therewith;
a container spacer device disposed adjacent to said conveying unit between said feed-in end and said container sensor, said container spacer device including a spacer motor and a spacer wheel driven rotatably by said spacer motor, said spacer wheel being adapted to contact a further one of the containers that is behind said another one of the containers in the advancing direction of said conveying unit such that rotation of said spacer wheel can result in retarding or advancing of said further one of the containers on said conveying unit, thereby resulting in a spacing between said another and further ones of the containers; and
a controller coupled electrically to said spacer motor, said container sensor and said label applying unit, said controller activating said label applying unit according to the container detect signal from said container sensor, and controlling said spacer motor to vary rotational speed of said spacer wheel according to length of time between successive ones of the container detect signals from said container sensor so that successive ones of the containers can be appropriately spaced apart prior to reaching said label applicator plate.

2. The labeling machine of claim 1, where said spacer wheel is made from a resilient rubber material.

3. The labeling machine of claim 1, further comprising an encoder unit associated with said conveying unit and coupled electrically to said controller, said encoder unit being operable so as to provide distance information to said controller to indicate distance advanced by the first one of the containers during attachment of the label thereon, said controller determining the appropriate spacing between successive ones of the containers based on the distance information from said encoder unit, and controlling said spacer motor according to the appropriate spacing determined thereby.
